(19) United States
(12) Patent Application Publication
(10) Pub. No.: US 2014/0145533 A1
(43) Pub. Date: May 29, 2014

(54) SEALING MODULE OF HYDRODYNAMIC BEARING AND SPINDLE MOTOR HAVING THE SAME

(71) Applicant: SAMSUNG ELECTRO-MECHANICS CO., LTD., Suwon (KR)

(72) Inventor: Hyun Ho Shin, Suwon (KR)

(73) Assignee: SAMSUNG ELECTRO-MECHANICS CO., LTD., Suwon (KR)

(21) Appl. No.: 14/091,314

(22) Filed: Nov. 26, 2013

(30) Foreign Application Priority Data
Nov. 27, 2012 (KR) 10-2012-0135423

(51) Int. Cl. F16J 15/447; H02K 7/08

(52) U.S. Cl. CPC F16J 15/447; H02K 7/086
USPC 310/90; 277/412

(57) ABSTRACT

Disclosed herein is a sealing module of a hydrodynamic bearing in which oil is filled in a micro gap between a shaft and a sleeve to form a hydrodynamic bearing part, wherein the shaft is fixedly coupled to a holder, the sleeve is rotatably supported by the shaft, the sleeve and the holder include bent parts formed at facing surfaces thereof in a direction perpendicular to an axial direction of the shaft respectively, and a maze type sealing part is formed by the bent parts.

### CROSS REFERENCE TO RELATED APPLICATION

This application claims the benefit of Korean Patent Application No. 10-2012-0135423, filed on Nov. 27, 2012, entitled “Sealing Module of Hydrodynamic Bearing and Spindle Motor having the same”, which is hereby incorporated by reference in its entirety into this application.

### BACKGROUND OF THE INVENTION

1. Technical Field

The present invention relates to a sealing module of a hydrodynamic bearing and a spindle motor having the same.

2. Description of the Related Art

Generally, in a spindle motor used as a driving device of a recording disk such as a hard disk, or the like, a fluid dynamic bearing using dynamic pressure generated by a lubricating fluid such as oil, or the like, stored between a rotor part and a stator part at the time of rotation of the motor, has been widely used.

More specifically, since the spindle motor including the fluid dynamic bearing that maintains shaft rigidity of a shaft only by movable pressure of lubricating oil by centrifugal force is based on centrifugal force, metal friction does not occur and a sense of stability increases as a rotation speed increases, such that the generation of noise and vibration is reduced and a rotating object can be more readily rotated at a high speed than a motor having a ball bearing. As a result, the spindle motor has been mainly applied to a high end optical disk device, a magnetic disk device, or the like.

In addition, in a spindle motor according to the prior art including the following Related Art Document, an oil sealing part for sealing oil injected in order to form hydrodynamic bearing is formed. In the case in which external impacted is applied, in a rotor part and a stator part of a hydrodynamic bearing part, relative motion is instantly generated.

Therefore, strong pressure wave is generated in oil, and the pressure wave is transferred to an oil interface, such that an oil leak is generated. In addition, the oil leak causes an insufficiency of the oil, such that performance of the motor may be deteriorated due to insufficiency of the oil.

In order to prevent an oil leak as described above, a sealing part having a tapered shape is formed, and the oil interface may be maintained by surface tension so that the oil leak is not generated. However, in the case in which large impact is instantly applied, the oil leak is generated, and the oil is evaporated to the outside, such that a lifespan of the motor may be reduced, and the motor may be unstably driven.

### PRIOR ART DOCUMENT

### Patent Document

(Patent Document 1) US Patent Laid-open Publication No. 2009-0276996

### SUMMARY OF THE INVENTION

The present invention has been made in an effort to provide a sealing module of a hydrodynamic bearing capable of preventing an oil leak by forming a bent part at an oil sealing part to generate a damping effect of oil flow by the bent part when external impact is generated, and a spindle motor having the same.

The present invention has been made in another effort to provide a sealing module of a hydrodynamic bearing capable of preventing an oil leak caused by instant generation of negative pressure in the case in which a rotor part ascends or descends due to external impact by forming an oil storage groove at an outer peripheral portion of a shaft facing the rotor part, and a spindle motor having the same.

According to a preferred embodiment of the present invention, there is provided a sealing module of a hydrodynamic bearing in which oil is filled in a micro gap between a shaft and a sleeve to form a hydrodynamic bearing part, wherein the shaft is fixedly coupled to a holder, the sleeve is rotatably supported by the shaft, the sleeve and the holder include bent parts formed at facing surfaces thereof in a direction perpendicular to an axial direction of the shaft, respectively, and a maze type sealing part is formed by the bent parts.

The bent part of the sleeve may be protruded and depressed at an outer peripheral portion of the sleeve so that a protrusion part and a groove part are alternately disposed, and the bent part of the holder may include a groove part formed so as to face the protrusion part of the sleeve and a protrusion part formed so as to face the groove part of the sleeve.

The bent part of the sleeve may be continuously protruded and depressed upwardly from a lower end portion of the sleeve so that the protrusion part and the groove part are alternately disposed.

The bent part of the sleeve and the bent part of the holder may be formed in plural so that the protrusion part and the groove part facing the protrusion part are alternately disposed.

The sleeve may be positioned on the holder, and an outer peripheral surface of the shaft may be provided with an oil storage groove facing a lower end portion of the sleeve.

The oil storage groove may be an annular groove formed in a circumferential direction of the shaft.

According to another preferred embodiment of the present invention, there is provided a spindle motor including: a rotor part including a sleeve integrated hub and a magnet coupled to an inner peripheral portion of the hub; and a stator part including a shaft rotatably supporting the sleeve integrated hub, a holder to which the shaft is fixedly coupled, a base to which the holder is coupled, and armature coupled to an outer peripheral surface of the base so as to face the magnet, wherein a hydrodynamic bearing part is formed between the rotor part and the stator part by filling oil, which is a working fluid, the sleeve integrated hub of the rotor part and the holder of the stator part facing the sleeve integrated hub include bent parts formed at facing surfaces thereof, respectively, and a maze type sealing part is formed by the bent parts.

The bent part of the sleeve integrated hub may be protruded and depressed at an outer peripheral portion of the sleeve integrated hub so that a protrusion part and a groove part are alternately disposed, and the bent part of the holder may include a groove part formed so as to face the protrusion part of the sleeve integrated hub and a protrusion part formed so as to face the groove part of the sleeve integrated hub.

The bent part of the sleeve integrated hub may be continuously protruded and depressed upwardly from a lower end portion of the sleeve integrated hub so that the protrusion part and the groove part are alternately disposed.

The bent part of the sleeve integrated hub and the bent part of the holder may be formed in plural so that the protrusion part and the groove part are alternately disposed.

The sleeve integrated hub may be positioned on the holder, and an outer peripheral surface of the shaft may be provided with an oil storage groove facing a lower end portion of the sleeve integrated hub.

The oil storage groove may be an annular groove formed in a circumferential direction of the shaft.

The stator part may further include a sealing member coupled to an upper end portion of the shaft and positioned so as to face the sleeve integrated hub, and an upper oil sealing part for sealing oil may be formed at a gap of the sleeve integrated hub.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a cross-sectional view schematically showing a sealing module of a hydrodynamic bearing according to a preferred embodiment of the present invention;

FIG. 2 is a cross-sectional view schematically showing a spindle motor mounted with the sealing module of a hydrodynamic bearing according to the preferred embodiment of the present invention; and

FIGS. 3A to 3C are cross-sectional views of states of the spindle motor shown in FIG. 2, wherein FIG. 3A shows a normal state, FIG. 3B shows a state in which a rotor part ascends, and FIG. 3C shows a state in which a rotor part descends.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

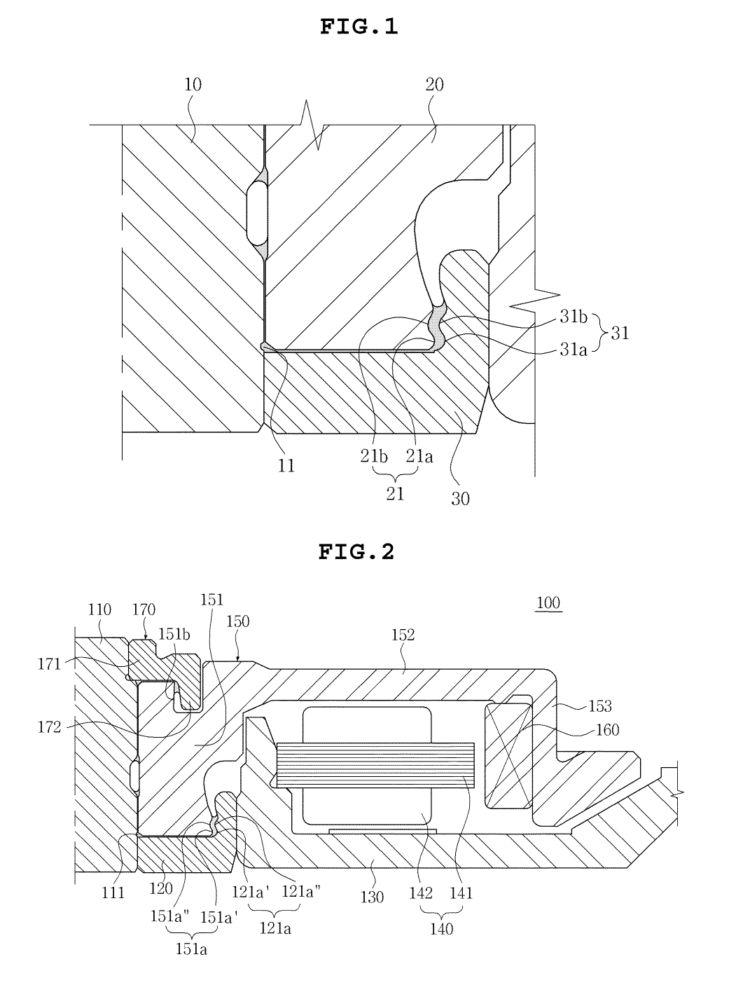

FIG. 1 is a cross-sectional view schematically showing a sealing module of a hydrodynamic bearing according to a preferred embodiment of the present invention.

As shown FIG. 1, the sealing module of a hydrodynamic bearing includes a shaft 10, a sleeve 20, and a holder 30, wherein a micro gap between the shaft and the sleeve is filled with oil to form a hydrodynamic bearing part, bent parts are formed at surfaces of the sleeve 20 and the holder facing each other, respectively, in a direction perpendicular to an axial direction of the shaft 10, and a maze type sealing part is formed by the bent parts.

More specifically, the shaft 10, which is a stator part, is fixedly coupled to an inner peripheral portion of the holder 30. In addition, the sleeve 20, which is a rotor part, is rotatably coupled to an outer peripheral portion of the shaft 10 and positioned on the holder 30.

Further, the sleeve 20 includes a bent part 21 formed at an outer peripheral portion of the sleeve 20 facing the holder in a radial direction of the shaft 10. Furthermore, the bent part 21 is continuously protruded and depressed upwardly from a lower end portion of the outer peripheral portion of the sleeve so that a protrusion part 21a and a groove part 21b are alternately disposed.

In addition, a bent part 31 is formed at one surface of the holder 30 facing the sleeve 20 in the radial direction of the shaft 10. Further, a groove part 31a and protrusion part 31b are alternately formed in the bent part 31 so as to face the protrusion part 21a and the groove part 21b of the sleeve, respectively.

Therefore, the maze type sealing part is formed by the bent part 21 of the sleeve and the bent part 31 of the holder, that is, by the protrusion part of the sleeve and the groove part of the holder facing the protrusion part of the sleeve and the groove part of the sleeve and the protrusion part of the holder facing the groove part of the sleeve.

In addition, a plurality of maze type sealing parts may be formed so that the protrusion part and the groove part facing the protrusion part are alternately disposed.

Further, in the sealing module of a hydrodynamic bearing according to the preferred embodiment of the present invention, an outer peripheral surface of the shaft may be provided with an oil storage groove 11 facing a lower end portion of the sleeve 20 in the axial direction of the shaft. The oil storage groove 11 is to prevent cavitation caused by generation of negative pressure at the time of ascending of the rotor part due to external impact, or the like.

Further, the oil storage groove 11 may be an annular groove formed in a circumferential direction of the shaft.

In the sealing module of a hydrodynamic bearing according to the preferred embodiment of the present invention configured as described above, the hydrodynamic bearing part is formed by injecting the oil into the micro gap between the shaft and the sleeve, the oil is filled in a micro gap between the sleeve and the holder in the axial direction of the shaft, and the maze type oil sealing part is formed at a gap between the sleeve and the holder in the radial direction of the shaft, that is, a gap between the bent part 21 of the sleeve and the bent part 31 of the holder.

FIG. 2 is a cross-sectional view schematically showing a spindle motor mounted with the sealing module of a hydrodynamic bearing according to the preferred embodiment of the present invention.

As shown in FIG. 2, the spindle motor 100 is configured of a stator part including a shaft 110, a holder 120, a base 130, an armature 140 configured of a core 141 and a coil 142, and a sealing member 170 and a rotor part including a sleeve integrated hub 150 and a magnet 160, and a hydrodynamic bearing is formed between the rotor part and the stator part by filling oil, which is working fluid.

In addition, a maze type sealing part provided with a bent part for sealing the oil is formed between the sleeve integrated hub 150 of the rotor part and the holder of the stator part facing the sleeve integrated hub.

More specifically, in the rotor part, the sleeve integrated hub 150 is rotatably supported by the shaft 110. In addition, an inner diameter portion of the sleeve integrated hub 150 has a micro gap with an outer diameter portion of the shaft 110, and the micro gap is filled with oil, such that a radial dynamic pressure bearing part is formed. To this end, the inner diameter portion of the sleeve or the outer diameter portion of the shaft includes a dynamic pressure generation groove selectively formed therein.

Further, the sleeve integrated hub 150 is configured of a sleeve part 151 facing the shaft and having a cylindrical shape, a disk part 152 extended from the sleeve part 151 in an outer diameter direction, and a side wall part 153 extended downwardly in the axial direction of the shaft from an end portion of the disk part 152 in the outer diameter direction.

In addition, in order to seal the oil, the sleeve part 151 is provided with an upper sealing part 151b at an upper portion and a bent part 151a, which is a lower sealing part, at a lower portion in the axial direction of the shaft. Further, the upper sealing part 151b is a groove part formed so as to partially correspond to the sealing member 170.

In addition, the upper sealing part 151b may be an annular groove formed so as to be extended in a circumferential direction of the sleeve.

Further, the bent part 151a, which is the lower sealing part, is formed at an outer peripheral portion of the sleeve integrated hub 150 facing the holder 120 in a radial direction of the shaft 110. In addition, in the bent part 151a, the sleeve integrated hub 150 is continuously protruded and depressed so as to face the holder to form a protrusion part 151a′ and a groove part 151a″, wherein the protrusion part 151a′ and the groove part 151a″ are formed so as to be alternately and upwardly disposed from a lower end portion of the outer peripheral portion of the sleeve integrated hub 150.

In addition, the sidewall part 153 includes an annular ring shaped magnet 160 mounted on an inner peripheral surface thereof so as to face the armature 140 including the core 141 and the coil 142.

In the spindle motor mounted with the sealing module of a hydrodynamic bearing according to the preferred embodiment of the present invention, the sleeve integrated hub may be formed by separately forming a sleeve and a hub and then coupling the sleeve and the hub to each other.

Next, in the stator part, the shaft 110 rotatably supports the sleeve integrated hub 150 as described above and includes the sealing member 170 fixedly coupled to an upper end portion thereof and the holder 120 fixed to a lower end portion thereof by press-fitting, adhesion, or the like.

In addition, an outer peripheral surface of the shaft may be provided with an oil storage groove 111 facing a lower end portion of the sleeve 20 in the axial direction of the shaft 110. The oil storage groove 111 is to prevent cavitation caused by generation of negative pressure at the time of ascending the sleeve integrated hub 150, which is the rotor part, due to external impact, or the like.

Further, the oil storage groove 111 may be an annular groove formed in a circumferential direction of the shaft.

In addition, the holder 120 includes a sealing part formed at one surface facing the lower sealing part of the sleeve integrated hub 150 in the radial direction of the shaft 110. Further, the sealing part is configured of a bent part 121a. Furthermore, in the bent part 121a, a groove part 121a′ and a protrusion part 121a″ are formed so as to face the protrusion part 151a′ and the groove part 151a″ of the lower sealing part of the sleeve integrated hub, respectively to thereby be alternately disposed.

Therefore, the maze type sealing part is formed by the bent part 151a of the sleeve integrated hub 150 and the bent part 121a of the holder 120. That is, the maze type sealing part is formed by the protrusion part of the sleeve integrated hub and the groove part of the holder facing the protrusion part of the sleeve integrated hub and the groove part of the sleeve integrated hub and the protrusion part of the holder facing the groove part of the sleeve integrated hub.

In addition, a plurality of maze type sealing parts may be formed so that the protrusion part and the groove part facing the protrusion part are alternately disposed.

Next, the base 130 includes the holder press-fitted to an inner peripheral portion thereof and the armature 140 fixedly coupled to an outer peripheral portion thereof by press-fitting, adhesion, or the like, so as to face the magnet 160, wherein the armature 140 includes the core 141 and the coil 142.

In addition, in the spindle motor according to the preferred embodiment of the present invention, the holder 120 and the base 130 may be formed integrally with each other.

In addition, the sealing member 170, which is to form the upper sealing part together with the sleeve integrated hub 150, is coupled to the upper end portion of the shaft. To this end, the sealing member 170 includes a coupling part 171 coupled to the shaft 110 so as to correspond to an outer diameter portion of the shaft and a sealing part 172 so as to correspond to the upper sealing part 151b of the sleeve integrated hub 150. In addition, the sealing part 172 may have a tapered shape.

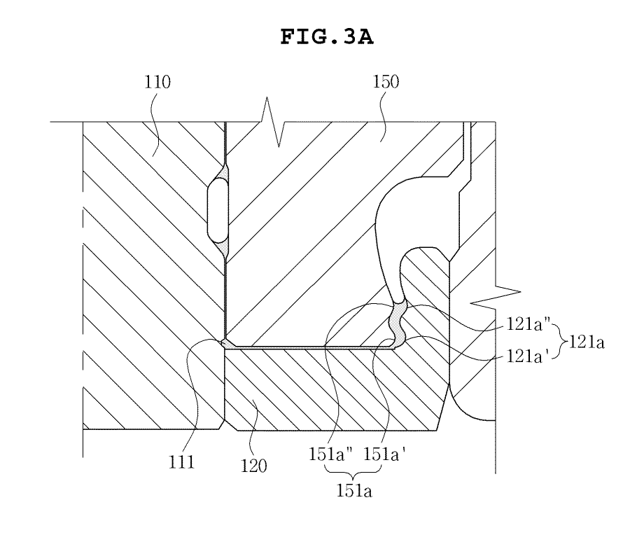

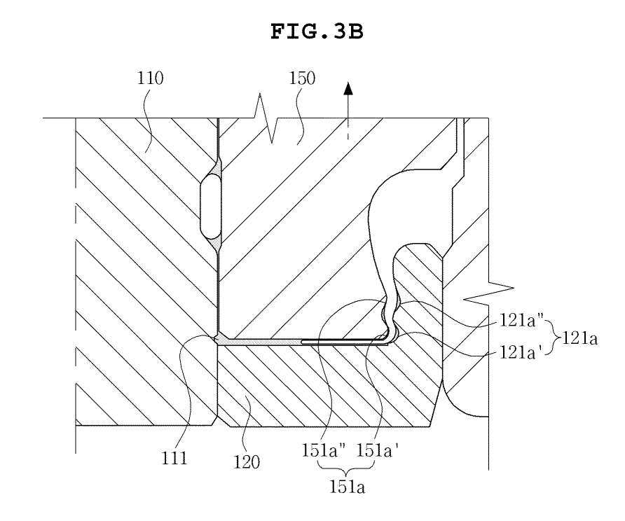

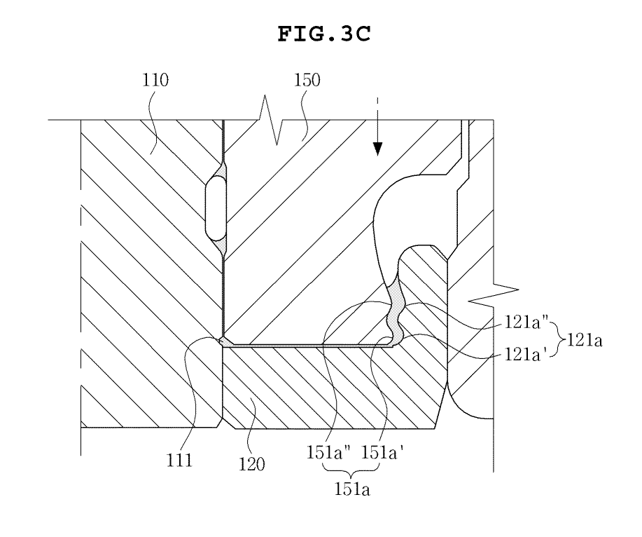

FIGS. 3A to 3C are cross-sectional views of states of the spindle motor shown in FIG. 2, wherein FIG. 3A shows a normal state, FIG. 3B shows a state in which a rotating part ascends, and FIG. 3C shows a state in which a rotating part descends.

As shown in FIG. 3A, in the spindle motor, the maze type sealing part is formed by the bent part 151a of the sleeve integrated hub 150 and the bent part 121a of the holder 120 in the normal state.

Further, in the case in which the rotor part ascends due to external impact, or the like, oil is introduced into a gap between the sleeve integrated hub 150 and the holder 120 as shown in FIG. 3B.

Then, in the case in which the rotor part descends, the oil is introduced again into the maze type sealing part between the sleeve integrated hub 150 and the holder 120 as shown in FIG. 3C. At this time, an inflow rate of oil is reduced while oil passes through the bent part, such that the oil leak may be prevented.

According to the present invention, the sealing module of a hydrodynamic bearing capable of preventing the oil leak by forming the bent part at the oil sealing part to generate the damping effect of oil flow by the bent part when external impact is generated and preventing the oil leak caused by instant generation of negative pressure in the case in which the rotor part ascends or descends due to external impact by forming the oil storage groove at the outer peripheral portion of the shaft facing the rotor part, and the spindle motor having the same may be obtained.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A sealing module of a hydrodynamic bearing in which oil is filled in a micro gap between a shaft and a sleeve to form a hydrodynamic bearing part,
wherein the shaft is fixedly coupled to a holder, the sleeve is rotatably supported by the shaft,
the sleeve and the holder include bent parts formed at facing surfaces thereof in a direction perpendicular to an axial direction of the shaft, respectively, and a maze type sealing part is formed by the bent parts.

2. The sealing module as set forth in claim 1, wherein the bent part of the sleeve is protruded and depressed at an outer peripheral portion of the sleeve so that a protrusion part and a groove part are alternately disposed, and
the bent part of the holder includes a groove part formed so as to face the protrusion part of the sleeve and a protrusion part formed so as to face the groove part of the sleeve.

3. The sealing module as set forth in claim 2, wherein the bent part of the sleeve is continuously protruded and depressed upwardly from a lower end portion of the sleeve so that the protrusion part and the groove part are alternately disposed.

4. The sealing module as set forth in claim 2, wherein the bent part of the sleeve and the bent part of the holder are formed in plural so that the protrusion part and the groove part facing the protrusion part are alternately disposed.

5. The sealing module as set forth in claim 1, wherein the sleeve is positioned on the holder, and an outer peripheral surface of the shaft is provided with an oil storage groove facing a lower end portion of the sleeve.

6. The sealing module as set forth in claim 5, wherein the oil storage groove is an annular groove formed in a circumferential direction of the shaft.

7. A spindle motor comprising:
a rotor part including a sleeve integrated hub and a magnet coupled to an inner peripheral surface of the hub; and
a stator part including a shaft rotatably supporting the sleeve integrated hub, a holder to which the shaft is fixedly coupled, a base to which the holder is coupled, and armature coupled to an outer peripheral portion of the base so as to face the magnet,
wherein a hydrodynamic bearing part is formed between the rotor part and the stator part by filling oil, which is a working fluid,
the sleeve integrated hub of the rotor part and the holder of the stator part facing the sleeve integrated hub include bent parts formed at facing surfaces thereof, respectively, and a maze type sealing part is formed by the bent parts.

8. The spindle motor as set forth in claim 7, wherein the bent part of the sleeve integrated hub is protruded and depressed at an outer peripheral portion of the sleeve integrated hub so that a protrusion part and a groove part are alternately disposed, and
the bent part of the holder includes a groove part formed so as to face the protrusion part of the sleeve integrated hub and a protrusion part formed so as to face the groove part of the sleeve integrated hub.

9. The spindle motor as set forth in claim 8, the bent part of the sleeve integrated hub is continuously protruded and depressed upwardly from a lower end portion of the sleeve integrated hub so that the protrusion part and the groove part are alternately disposed.

10. The spindle motor as set forth in claim 8, wherein the bent part of the sleeve integrated hub and the bent part of the holder are formed in plural so that the protrusion part and the groove part are alternately disposed.

11. The spindle motor as set forth in claim 7, wherein the sleeve integrated hub is positioned on the holder, and an outer peripheral surface of the shaft is provided with an oil storage groove facing a lower end portion of the sleeve integrated hub.

12. The spindle motor as set forth in claim 11, wherein the oil storage groove is an annular groove formed in a circumferential direction of the shaft.

13. The spindle motor as set forth in claim 7, wherein the stator part further includes a sealing member coupled to an upper end portion of the shaft and positioned so as to face the sleeve integrated hub, and an upper oil sealing part for sealing oil is formed at a gap of the sleeve integrated hub.
